(19) United States
(12) Patent Application Publication
(10) Pub. No.: US 2025/0174789 A1
(43) Pub. Date: May 29, 2025

(54) BATTERY PACK

(71) Applicant: HONDA MOTOR CO., LTD., Tokyo (JP)

(72) Inventors: Daigo KOMATSU, Tokyo (JP); Keiji TAKEUCHI, Tokyo (JP)

(73) Assignee: HONDA MOTOR CO., LTD., Tokyo (JP)

(21) Appl. No.: 18/950,231

(22) Filed: Nov. 18, 2024

(30) Foreign Application Priority Data
Nov. 24, 2023 (JP) 2023-199081

(51) Int. Cl. H01M 50/209; H01M 50/249; H01M 50/251; H01M 50/271; H01M 50/517

(52) U.S. Cl. CPC H01M 50/209; H01M 50/271; H01M 50/517; H01M 50/249; H01M 50/251

(57) ABSTRACT

A battery pack includes: a cell laminate in which plural battery cells are laminated; and a case that accommodates the cell laminate, and the case includes a cell accommodation space in which the cell laminate is accommodated and which is closed from an outside, an output terminal accommodation space in which a conductive member extending from the cell accommodation space and an external conductive member entering through an opening are electrically connected, and a lid member configured to detachably close the opening.

### CROSS-REFERENCE TO RELATED APPLICATION

This application is based on and claims priority under 35 USC 119 from Japanese Patent Application No. 2023-199081 filed on Nov. 24, 2023.

### TECHNICAL FIELD

The present invention relates to a battery pack.

### BACKGROUND ART

In recent years, researches and developments have been conducted on a secondary battery which contributes to improvement in energy efficiency in order to allow more people to have access to affordable, reliable, sustainable and advanced energy.

An electric vehicle or a hybrid vehicle in the conventional art is mounted with a single battery pack obtained by accommodating a plurality of battery modules in a battery case (for example, JP2000-62472A). However, this case requires to design a battery pack for each vehicle, and thus has no versatility of battery packs.

JP5945785B proposes a replaceable battery. JP5945785B discloses that, in order to facilitate attachment and detachment of the battery and a cable terminal at the time of replacement, a slit is provided in a terminal block, and a cam lever exposed to the outside is pivoted in a state where a Y-shaped (U-shaped) terminal of a cable is inserted from the slit, to fasten terminals to each other.

### SUMMARY OF INVENTION

In JP5945785B, since the terminal of the cable is inserted from the slit of the terminal block, the terminal of the cable cannot be a terminal other than the U-shaped terminal, and there is a problem in versatility. On the other hand, if a connection terminal of the terminal block is exposed at the time of conveyance or the like, there is a possibility that foreign matters enter an inside of the battery pack, which is not preferable.

The present invention provides a battery pack that can prevent entry of foreign matters at the time of conveyance and has high versatility. This further contributes to the improvement in energy efficiency.

The present invention relates to a battery pack including:
a cell laminate in which a plurality of battery cells are laminated; and
a case that accommodates the cell laminate, in which
the case includes
a cell accommodation space that accommodates the cell laminate and is closed from the outside,
an output terminal accommodation space in which a conductive member extending from the cell accommodation space and an external conductive member entering through an opening are connected, and
a lid member configured to detachably close the opening.

According to the present invention, it is possible to mount the battery pack on various devices while preventing foreign matters from entering the case.

### BRIEF DESCRIPTION OF DRAWINGS

FIG. 1 is an external perspective view of a battery pack 10.

FIG. 2 is an exploded perspective view of the battery pack 10.

FIG. 3 is an exploded perspective view of a cell laminate 30.

FIG. 4 is a plan view of the battery pack 10.

FIG. 5 is a view showing an output terminal accommodation space 27 of a modification.

FIG. 6 is an external perspective view of a battery assembly 100.

FIG. 7 is an external perspective view of the battery assembly 100 when viewed from a bottom surface, with a bottom cover 126 being disassembled.

FIG. 8 is an external perspective view of a central frame 120.

FIG. 9 is an external perspective view of the central frame 120 when viewed from the bottom surface, with the bottom cover 126 being disassembled.

FIG. 10 is a side view of a four-wheeled vehicle 301 in which the battery assembly 100 is disposed under a floor.

FIG. 11 is a side view of a two-wheeled vehicle 302 on which a battery assembly 100A is mounted.

FIG. 12 is a side view of a lawn mower 303 on which the battery assembly 100A is mounted.

FIG. 13 is a side view of a conveyance carriage 304 on which the battery assembly 100A is mounted.

FIG. 14 is a side view of an electric power unit 305 on which a battery assembly 100B is mounted.

### DESCRIPTION OF EMBODIMENTS

Hereinafter, an embodiment of a battery pack of the present invention will be described with reference to the accompanying drawings. In the following description, for convenience, a coordinate system including a front-rear direction, a left-right direction, and an upper-lower direction orthogonal to each other is used. In the drawings, a front side is denoted by Fr, a rear side is denoted by Rr, a left side is denoted by L, a right side is denoted by R, an upper side is denoted by U, and a lower side is denoted by D. However, these directions are not related to a direction when the battery pack is mounted on a device. For example, when the battery pack is mounted on a vehicle, an upper-lower direction of the battery pack may be oriented in a traveling direction of the vehicle or in a vehicle width direction when the battery pack is mounted on the vehicle.

### [Battery Pack]

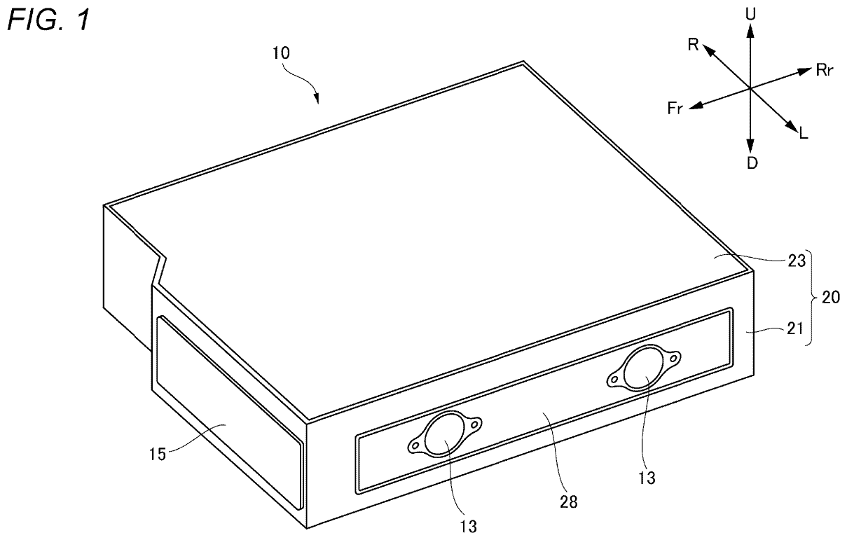

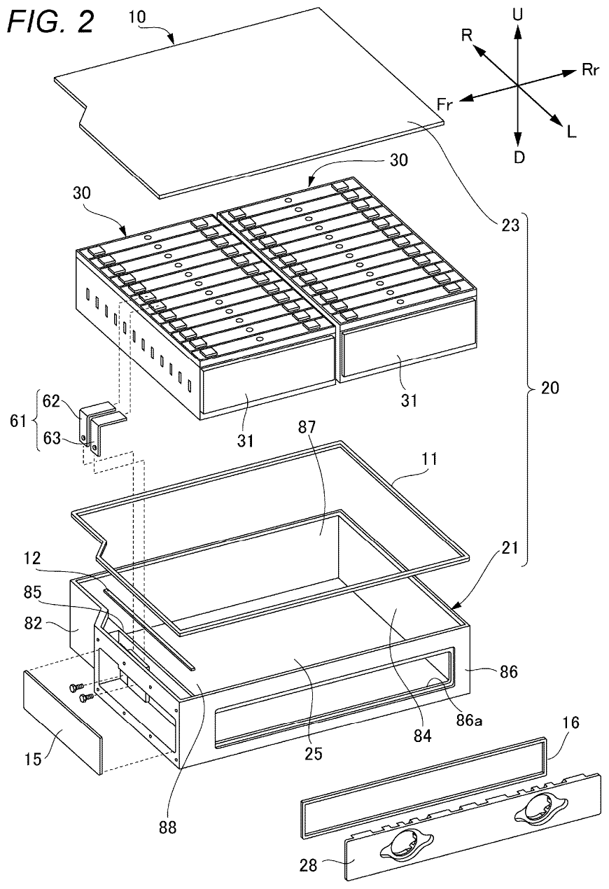

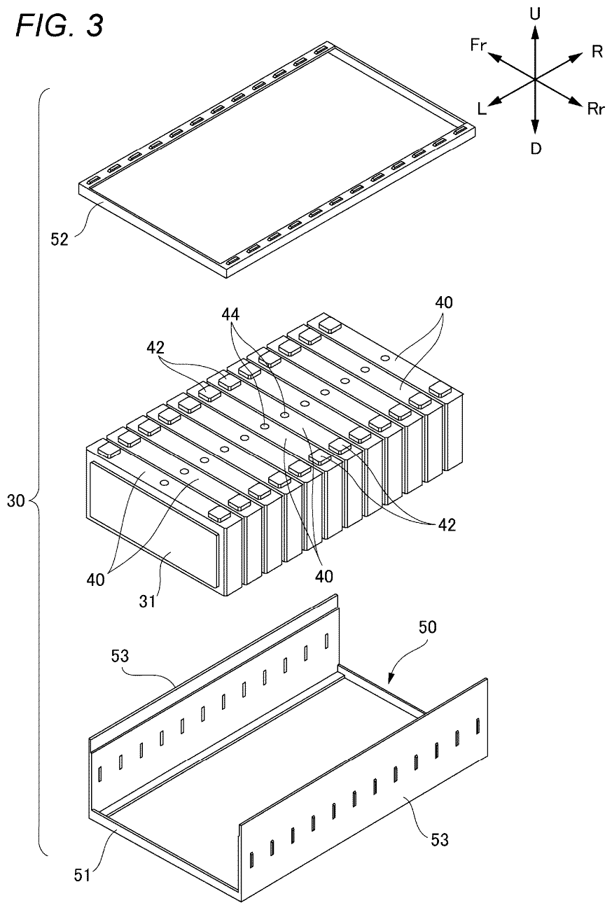

In a battery pack 10, as shown in FIGS. 1 and 2, two cell laminates 30 are arranged in a front-rear direction inside a box-shaped case 20. As shown in FIG. 3, the cell laminate 30 includes a plurality of square battery cells 40 laminated in a left-right direction, and an end plate 31 disposed on one side in the left-right direction (left side in the present embodiment), which are temporarily fixed at a predetermined pressure by using a binder 50. A separator (not shown) may be disposed between adjacent battery cells 40. The binder 50 includes a rectangular lower restraining portion 51 surrounding a bottom surface of the cell laminate 30, a rectangular upper restraining portion 52 surrounding an upper surface of the cell laminate 30, and a pair of side restraining portions 53 sandwiching the cell laminate 30 in the front-rear direction, and the lower restraining portion 51 and the pair of side restraining portions 53 are formed integrally. Another end plate, a separator, or the like may be disposed on the other side of the cell laminate 30 in the left-right direction (right side in the present embodiment), and the battery cells 40 are not in direct contact with the case 20 on the other side. The cell laminate 30 may not be configured such that the plurality of battery cells 40 are restrained by the binder 50. That is, the plurality of battery cells 40 may be directly laminated inside the case 20.

The battery cells 40 are each, for example, a secondary battery such as a lithium ion battery. An upper surface of the battery cell 40 is provided with a pair of terminals 42 and a safety valve 44 disposed between the pair of terminals 42. The pair of terminals 42 include a positive terminal and a negative terminal, and for example, the positive terminal is connected to the negative terminal of an adjacent battery cell 40 via a bus bar (not shown), and the negative terminal is connected to the positive terminal of an adjacent battery cell 40 via a bus bar (not shown), whereby the plurality of battery cells 40 are electrically connected in series. For example, in order to shorten a length of the bus bar, the plurality of battery cells 40 may be laminated such that orientations thereof in the front-rear direction are reversed alternately.

The safety valve 44 is a rupture valve, and prevents rupture of an outer can when an internal pressure of the battery cell 40 abnormally rises. If the internal pressure of the battery cell 40 abnormally rises, the safety valve 44 ruptures, and a gas in the battery cell 40 is discharged to the outside. By providing the safety valve 44 at a central portion of the battery cell 40 in the front-rear direction, the plurality of battery cells 40 can be aggregated at the same position in the front-rear direction even if the plurality of battery cells 40 are laminated such that the orientations thereof in the front-rear direction are reversed alternately.

Returning to FIG. 2, the case 20 includes a case body 21 whose upper side is open, and a case cover 23 that covers the opening of the case body 21. The case body 21 includes a front wall 82 and a rear wall 84 that extend in the left-right direction, a left wall 86 that connects left ends of the front wall 82 and the rear wall 84, a right wall 87 that connects right ends of the front wall 82 and the rear wall 84, and a bottom wall 88. A space surrounded by the front wall 82, the rear wall 84, the left wall 86, and the right wall 87 constitutes a cell accommodation space 25 for accommodating the cell laminates 30.

The left wall 86 is provided with an opening 86a that allows the cell accommodation space 25 to communicate with the outside, and is attached with a pressurization plate 28 via a seal member 16 (for example, a rubber seal). By fixing the pressurization plate 28 to the left wall 86, the pressurization plate 28 comes into contact with the end plate 31 of each cell laminate 30 from the opening 86a. When the pressurization plate 28 presses the end plate 31 inward, the cell laminate 30 temporarily fixed by the binder 50 at a predetermined pressure is further pressurized in the lamination direction and held in the case 20. The pressurization plate 28 may be fixed to the left wall 86 by welding such as friction stir welding, or may be fixed by bolts.

As shown in FIG. 1, the pressurization plate 28 is provided with two pressure relief valves 13 communicating with the cell accommodation space 25. When the internal pressure of the cell accommodation space 25 abnormally rises due to the gas generated from the safety valve 44 of the battery cell 40, the pressure relief valves 13 are opened to discharge the gas in the case 20 to the outside.

An expanded portion 22 is formed forward of and leftward of the front wall 82 in a manner protruding further forward of the front wall 82. The expanded portion 22 has a space formed inside, and has a first opening 91 provided in a front surface and a second opening 92 provided in an upper surface. The internal space of the expanded portion 22 is provided with a terminal block 60 connected with a lead-out conductive member 70, and forms an output terminal accommodation space 27. Electrically connected at the terminal block 60 are a terminal (output terminal) of an output conductive member 61 extending from the cell accommodation space 25 to the output terminal accommodation space 27, and a terminal of the lead-out conductive member 70 entering the output terminal accommodation space 27 through the first opening 91. The output conductive member 61 includes a positive-side bus bar 62 and a negative-side bus bar 63 respectively extending from a positive-side output terminal and a negative-side output terminal of the two cell laminates 30 electrically connected in series. The lead-out conductive member 70 includes a positive-side bus bar 72 and a negative-side bus bar 73 respectively connected to external positive terminal and negative terminal.

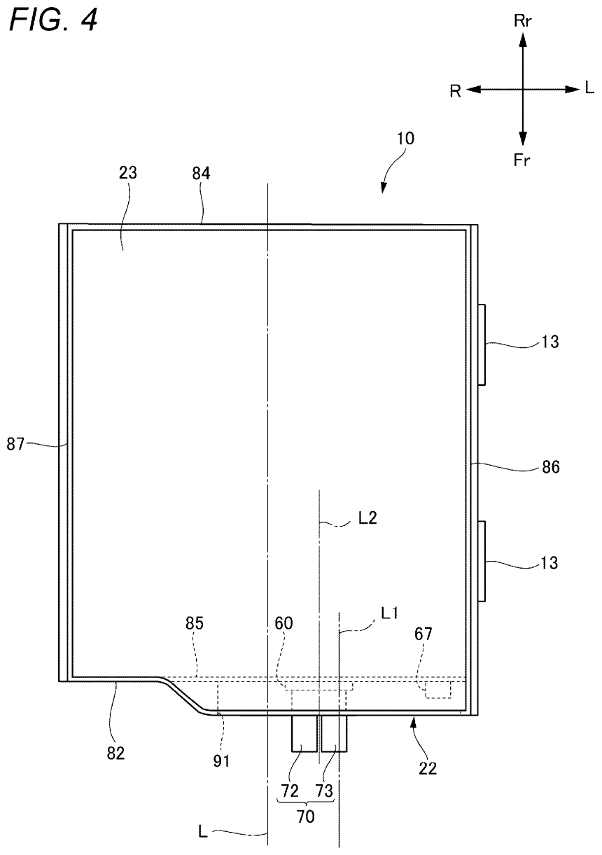

As shown in FIG. 4, the first opening 91 is offset in the left-right direction relative to a central line L in the left-right direction of the battery pack 10. That is, a central line L1 of the first opening 91 is offset in the left-right direction relative to the central line L in the left-right direction of the battery pack 10.

The terminal block 60 is also offset in the left-right direction relative to the central line L in the left-right direction of the battery pack 10. That is, a central line L2 of the terminal block 60 is offset in the left-right direction relative to the central line L in the left-right direction of the battery pack 10.

The fastening of the terminal of the output conductive member 61 and the terminal of the lead-out conductive member 70 is preferably bolt fastening. By bolt fastening, the terminals of the output conductive member 61 and the lead-out conductive member 70 may be of a round shape (R shape) or a front-opening type (Y shape). In this way, the battery pack 10 can be mounted on various devices by connecting the lead-out conductive member 70 from the first opening 91 of the output terminal accommodation space 27.

As described above, the inside of the case 20 has the cell accommodation space 25 that accommodates the two cell laminates 30, and the output terminal accommodation space 27 disposed forward of and leftward of the cell accommodation space 25 and connected with the lead-out conductive member 70. The number of the cell laminates 30 accommodated in the cell accommodation space 25 may be one or three or more.

A region of the front wall 82 that separates the cell accommodation space 25 from the output terminal accommodation space 27 (hereinafter, this portion is referred to as a partition wall 85) is lower in height than the other regions. The positive-side bus bar 62 and the negative-side bus bar 63 extend from above the partition wall 85 to the output terminal accommodation space 27, and are fixed to the terminal block 60 provided in the output terminal accommodation space 27.

As shown in FIG. 1, the output terminal accommodation space 27 is provided with a signal line connector 67. The signal line connector 67 is connected with a signal line via a through hole provided in the partition wall 85 to allow the cell accommodation space 25 to communicate with the output terminal accommodation space 27.

As shown in FIG. 2, an upper surface of the case 20 is attached with the case cover 23 via a first seal member 11 (for example, a rubber seal), except for the partition wall 85. The case cover 23 is fixed to the upper surface of the case 20 by welding such as friction stir welding, for example. A gap between the partition wall 85 and the case cover 23 is provided with a second seal member 12 (for example, a foamed seal), and the cell accommodation space 25 is sealed from the outside by the first seal member 11 and the second seal member 12. By sealing the cell accommodation space 25 from the outside, it is possible to prevent entry of foreign matters into the cell accommodation space 25, thereby preventing deterioration of the battery cells 40. It is preferable to further provide a seal member such as a foamed seal in a gap between the through hole provided in the partition wall 85 and the signal line.

As shown in FIG. 1, a lid member 15 detachably closes the first opening 91. The lid member 15 may be firmly fixed to the front surface of the expanded portion 22 by bolts or the like, or may be fixed by elastically fitting with resin, rubber, or the like. At the time of conveyance, the output terminal accommodation space 27 is closed by closing the first opening 91 with the lid member 15, and it is possible to prevent entry of foreign matters into the case 20. The lid member 15 is removed when the battery pack 10 is used.

The lid member 15 is preferably fixed to the front surface of the expanded portion 22 via a sealing member. By interposing a sealing member, a sealing function can be further improved, and the output terminal accommodation space 27 can be more reliably sealed. The sealing member is, for example, a rubber seal.

The battery pack 10 configured as described above does not include an auxiliary device such as an ECU or a junction box that accommodates a contactor, a fuse, and the like. Therefore, if the battery pack 10 is used alone, the battery pack 10 may be connected to a junction box and/or an ECU via a connection box 200, or a cable or the like. If a plurality of battery packs 10 are used, the battery packs 10 may be electrically connected to each other in the connection box 200, and the connection box 200 may be connected to a junction box and/or an ECU. Further, a junction box and/or an ECU may be incorporated in the connection box 200, and the plurality of battery packs 10, the junction box and/or the ECU may be connected in the connection box. The connection box 200 will be described later.

An upper surface of the case cover 23 preferably has a flat surface or a fitting shape to be fitted to the bottom wall portion 88 of the case body 21. Accordingly, if a device to be mounted requires two or more battery packs 10, the cases 20 can be laminated in an upper-lower direction. For example, it is assumed that the battery packs 10 are laminated in about five layers and used as a stationary type.

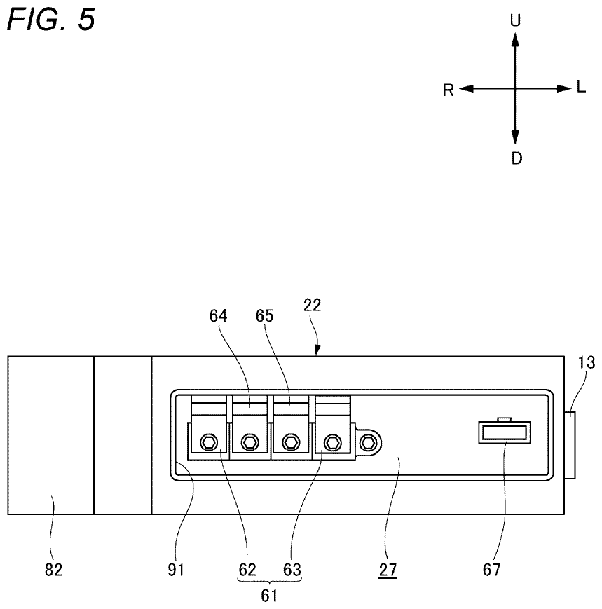

In the embodiment described above, only the positive-side bus bar 62 and the negative-side bus bar 63 of the output conductive member 61 extend from the cell accommodation space 25 to the terminal block 60 of the output terminal accommodation space 27, but midpoint bus bars 64 and 65 may extend from the cell accommodation space 25 as shown in FIG. 5. The midpoint bus bars 64 and 65 are interposed in the middle of the plurality of battery cells 40 connected in series, and are fastened to the terminal block 60 with bolts to establish electrical continuity in a series circuit. Therefore, at the time of fastening the output conductive member 61 (positive-side bus bar 62 and negative-side bus bar 63) and the lead-out conductive member 70 (positive-side bus bar 72 and negative-side bus bar 73), by removing the bolts from the midpoint bus bars 64 and 65 in advance, it is possible to prevent an accidental short circuit from occurring.

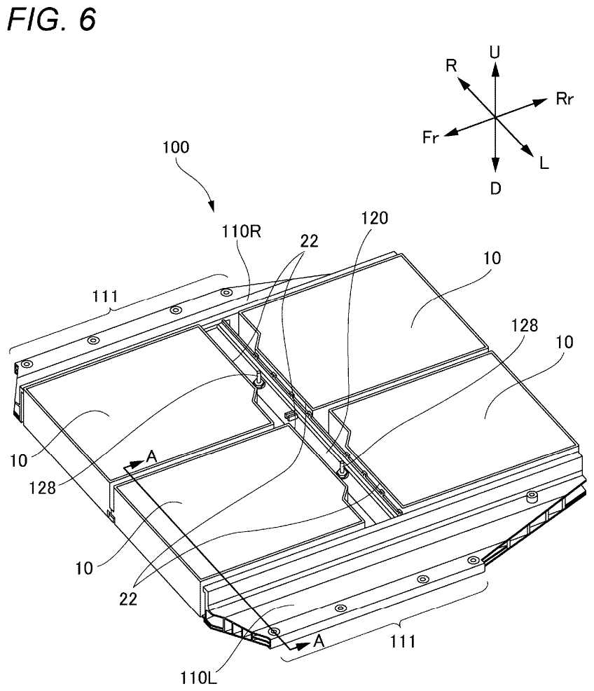

Next, a mounting structure for battery pack for mounting four battery packs 10 under a floor of a vehicle will be described with reference to FIGS. 6 to 9. In the following description, the front-rear direction, the left-right direction (vehicle width direction), and the upper-lower direction are defined with reference to the vehicle.

In this mounting structure, as shown in FIG. 6, a central frame 120 extending in the vehicle width direction is fixed between a left side frame 110L and a right side frame 110R extending in the front-rear direction of the vehicle. Two of the battery packs 10 are arranged in the left-right direction in a space forward of the central frame 120, and two of the battery packs 10 are arranged in the left-right direction in a space behind the central frame 120. Hereinafter, this structure will be referred to as a battery assembly 100.

### [Battery Assembly]

In the battery assembly 100, the two front battery packs 10 are arranged such that the expanded portion 22 is positioned on the rear and the right, and the two rear battery packs 10 are arranged such that the expanded portion 22 is positioned on the front and the left. That is, the two front battery packs 10 and the two rear battery packs 10 are arranged in a state of being rotated by 180° such that the expanded portions 22 face each other in the front-rear direction with the central frame 120 interposed therebetween.

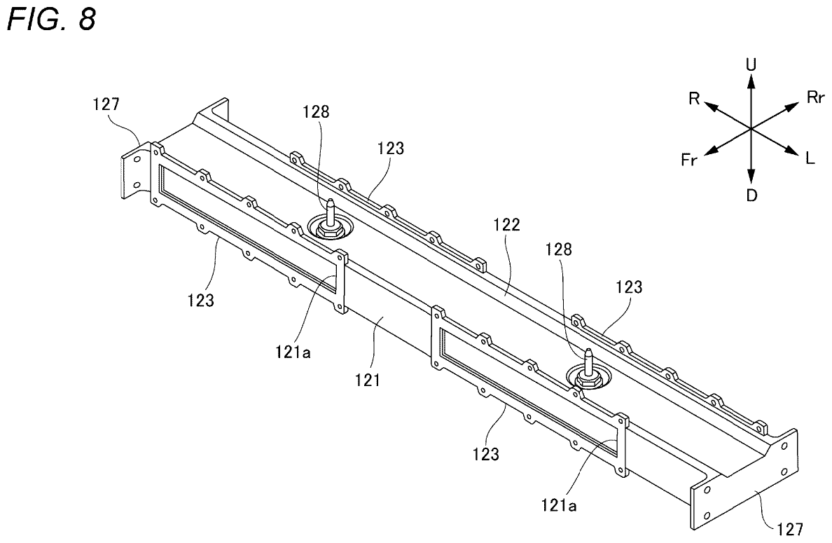

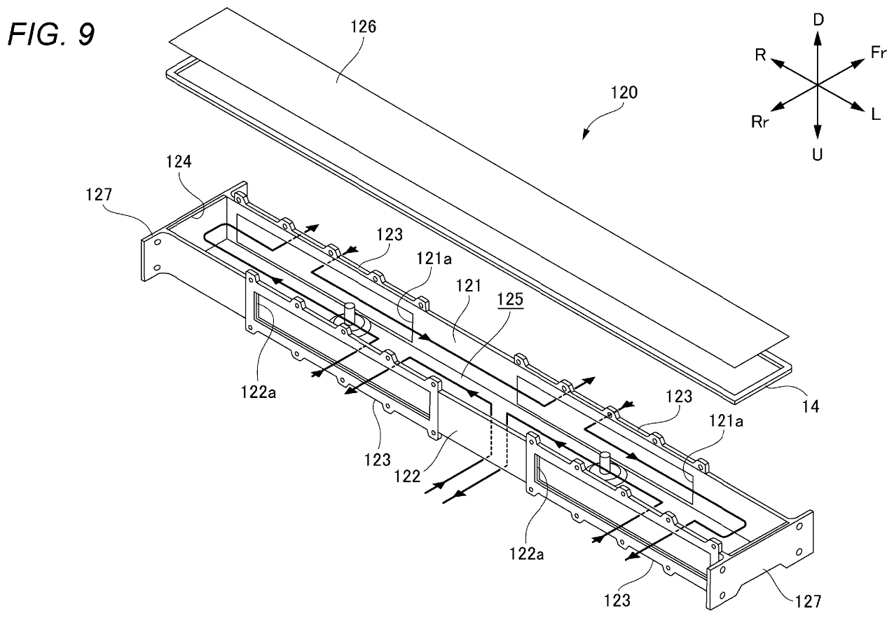

As shown in FIGS. 8 and 9, the central frame 120 of the battery assembly 100 is a hollow body having a rectangular cross section, and is fastened to the left side frame 110L and the right side frame 110R by flanges 127 formed at left and right ends and extending in the front-rear direction.

A front surface 121 of the central frame 120 is formed with two front communication holes 121a, which respectively communicate with the first openings 91 formed in the expanded portions 22 of the front battery packs 10. Similarly, a rear surface 122 of the central frame 120 is formed with two rear communication holes 122a, which respectively communicate with the first openings 91 formed in the expanded portions 22 of the rear battery packs 10.

Fastening portions 123 for fastening the corresponding battery packs 10 in a liquid-tight manner are provided around the front communication hole 121a and the rear communication hole 122a. Each battery pack 10 is fixed to the central frame 120 by, for example, bolt fastening. As shown in FIG. 8, the central frame 120 has the fastening portions 123 on the front surface 121 and the rear surface 122, respectively, and the front surface 121 and the rear surface 122 protrude vertically, thereby forming a high-rigidity cross-sectional shape like H steel in a cross section cut in the front-rear direction.

From the output terminal accommodation space 27 formed in the expanded portion 22 of each battery pack 10, the lead-out conductive member 70 enters a hollow region 125 of the central frame 120 through the first opening 91. As described above, since the terminal block 60 of each battery pack is offset in the left-right direction relative to the central line L, the terminal blocks 60 of the front battery packs 10 and the terminal blocks 60 of the rear battery packs 10 are offset in the left-right direction. Accordingly, the lead-out conductive members 70 connected to a bus bar unit 140 through the front communication holes 121a from the terminal blocks 60 of the front battery packs 10 and the lead-out conductive members 70 connected to the bus bar unit 140 through the rear communication holes 122a from the terminal blocks 60 of the rear battery packs 10 are offset in the vehicle width direction. Therefore, the lead-out conductive members 70 extending from the front battery packs 10 and the lead-out conductive members 70 extending from the rear battery packs 10 do not interfere with each other in the hollow region 125 of the central frame 120.

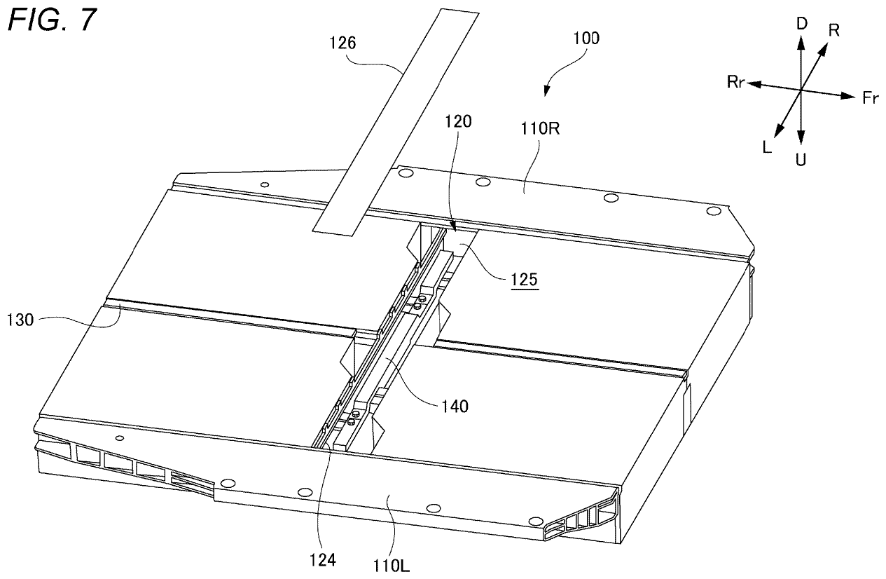

As shown in FIG. 7, the bus bar unit 140 is arranged in the hollow region 125 of the central frame 120. The bus bar unit 140 includes, for example, a plurality of connection bus bars, and electrically connects the four battery packs 10 in series as indicated by arrows in FIG. 9. The central frame 120 is an example of the above connection box 200.

A back surface of the central frame 120 is provided with a bottom opening 124. The bottom opening 124 is closed in a liquid-tight manner by a bottom cover 126 via a sealing member 14 (see FIG. 9). The bottom opening 124 of the central frame 120 is closed by the bottom cover 126 in a liquid-tight manner, and the communication holes 121a and 122a of the central frame 120 and the first openings 91 of the battery packs 10 are fastened in a liquid-tight manner. This restricts the entry of water from the outside into the output terminal accommodation space 27 of the battery pack 10 and the internal space of the central frame 120. The lead-out conductive member 70 extending from each battery pack 10 to the hollow region 125 of the central frame 120 is fastened to the bus bar unit 140 from the bottom opening 124 with the bottom cover 126 removed.

The battery assembly 100 configured as described above is fixed to a frame member of the vehicle by a pair of central supports 128 provided on the central frame 120 shown in FIG. 8, and side supports 111 provided on the left side frame 110L and the right side frame 110R shown in FIG. 6, and is arranged under the floor of the vehicle.

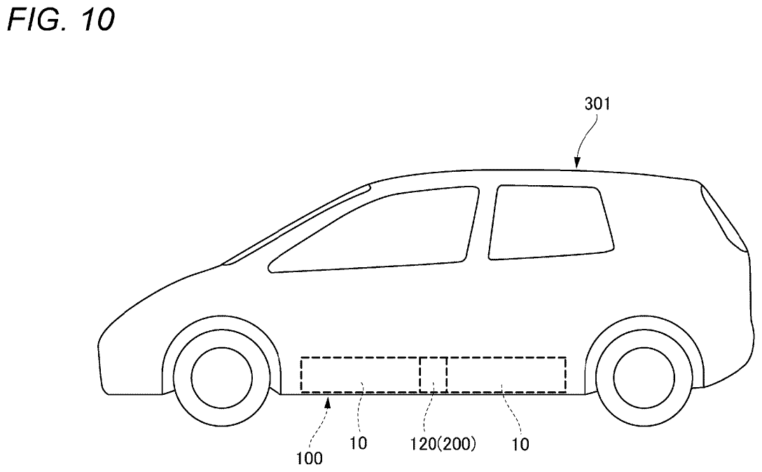

FIG. 10 is a side view of a four-wheeled vehicle 301 in which the battery assembly 100 is disposed under a floor. The four-wheeled vehicle 301 is configured to be operated by driving a motor (not shown) with electric power of the battery pack 10. The four-wheeled vehicle may be a hybrid vehicle, an electric automobile, or a fuel cell vehicle. The battery pack 10 may be mounted on various devices, including not only a four-wheeled vehicle, but also a vehicle such as a two-wheeled vehicle and a three-wheeled vehicle, a working machine such as a lawn mower and a leveling machine, and an electric battery unit, for example.

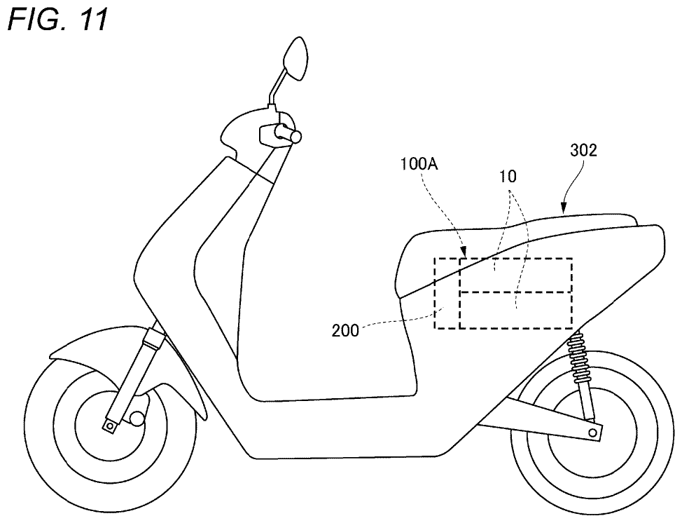

FIG. 11 is a side view of a two-wheeled vehicle 302 on which a battery assembly 100A is mounted.

The battery assembly 100A includes the battery packs 10 laminated in two upper and lower layers, and the connection box 200 disposed in front of the two battery packs 10 and electrically connecting the two battery packs 10. The two-wheeled vehicle 302 is configured to be operated by driving a motor (not shown) with electric power of the battery pack 10.

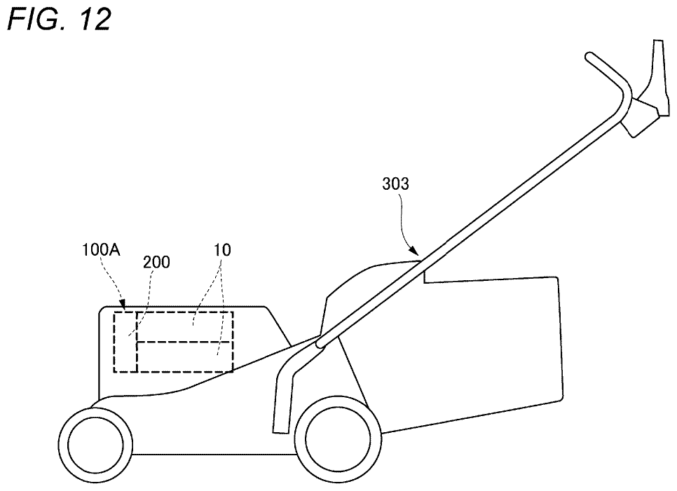

FIG. 12 is a side view of a lawn mower 303 on which the battery assembly 100A is mounted.

The lawn mower 303 rotates a blade by driving a motor (not shown) with electric power of the battery pack 10. The electric power of the battery pack 10 may be used to drive wheels in addition to rotating the blade.

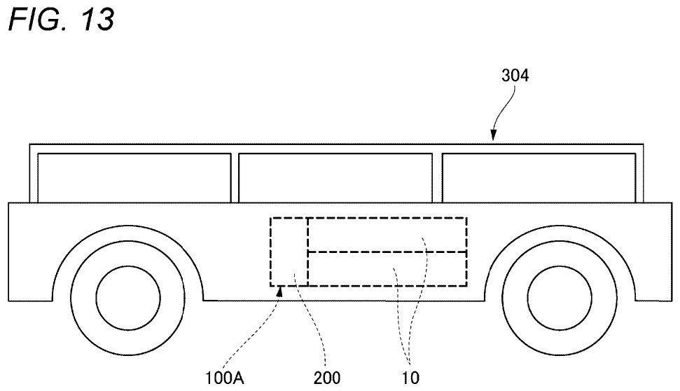

FIG. 13 is a side view of a conveyance carriage 304 on which the battery assembly 100A is mounted.

The conveyance carriage 304 is configured to be automatically operated by driving a motor (not shown) with electric power of the battery pack 10.

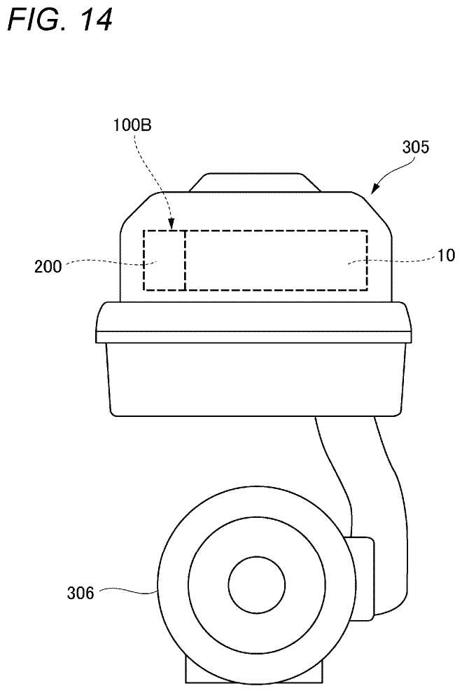

FIG. 14 is a side view of an electric power unit 305 on which a battery assembly 100B is mounted.

The battery assembly 100B includes one battery pack 10 and the connection box 200 disposed in front of the battery pack 10. The electric power unit 305 drives a motor 306 with electric power of the battery pack 10. The electric power unit 305 may be a separate type electric power unit in which the battery pack 10 and the motor 306 are separated from each other, or may be an integrated type electric power unit in which the battery pack 10 and the motor 306 are integrally accommodated in one case.

The number of the battery assemblies 100, 100A, and 100B is not limited as long as the battery assembly includes one or more battery packs 10. In addition to the above examples, the battery pack 10 may be used as a stationary battery in which a plurality of battery packs are laminated. The battery assemblies 100, 100A, and 100B, and/or the stationary battery may include one obtained by recycling or reusing the battery pack 10 after use for another purpose. By using the battery pack 10 after use for another purpose, the number of battery packs 10 to be discarded can be reduced, and resources can be effectively used.

Although various embodiments have been described above with reference to the drawings, it is needless to say that the present invention is not limited to these examples. It is apparent that those skilled in the art can conceive of various modifications and alterations within the scope described in the claims, and it is understood that such modifications and alterations naturally fall within the technical scope of the present invention. In addition, respective constituent elements in the above embodiment may be freely combined without departing from the gist of the invention.

For example, the battery packs 10 may be provided with a water jacket integrally with or separately from the bottom wall 88.

In the present specification, at least the following matters are described. Although corresponding constituent elements or the like in the above embodiment are shown in parentheses, the present invention is not limited thereto.

(1) A battery pack (battery pack 10) including:
a cell laminate (cell laminate 30) in which a plurality of battery cells (battery cells 40) are laminated; and
a case (case 20) that accommodates the cell laminate, in which
the case includes
a cell accommodation space (cell accommodation space 25) that accommodates the cell laminate and is closed from the outside,
an output terminal accommodation space (output terminal accommodation space 27) in which a conductive member (output conductive member 61) extending from the cell accommodation space and an external conductive member (lead-out conductive member 70) entering through an opening (first opening 91) are connected, and
a lid member (lid member 15) configured to detachably close the opening.

According to (1), the external conductive member entering the output terminal accommodation space through the opening is connected to the conductive member, so that the battery pack can be mounted on various devices. In addition, by closing the output terminal accommodation space with the lid member when the battery pack is conveyed, it is possible to prevent entry of foreign matters into the case.

(2) The battery pack according to (1), in which
a sealing member (second seal member 12) is provided at a communication portion between the cell accommodation space and the output terminal accommodation space, and
the cell accommodation space is sealed.

According to (2), by sealing the cell accommodation space, deterioration of the battery cell can be prevented even in a state where the lid member is not attached.

(3) The battery pack according to (1) or (2), in which
the conductive member and the external conductive member are configured to be capable of being electrically connected by a bolt.

According to (3), the battery pack has high versatility and can be mounted on various devices.

(4) The battery pack according to any one of (1) to (3), in which
a terminal block (terminal block 60) to which the conductive member and the external conductive member are connected is offset in a width direction of the battery pack relative to a central line (central line L) in the width direction.

According to (4), a position of the terminal block can be offset by arranging battery packs in a state of being rotated by 180° while facing each other in a front-rear direction. Accordingly, it is possible to prevent interference of the external conductive member extending from the terminal block of the battery pack and connected to the conductive member.

(5) The battery pack according to any one of (1) to (4), in which
an upper surface of the case has a flat surface or a fitting shape to be fitted to a bottom surface of the case, and
the case is configured to be capable of being laminated in an upper-lower direction.

According to (5), a plurality of battery packs can be mounted in a laminated state in accordance with devices.

(6) The battery pack according to any one of (1) to (5), in which
the battery pack is mounted on an electric power unit (electric power unit 305) configured to drive a motor with electric power of the battery pack.

According to (6), the battery pack can be used as a battery of an electric power unit that can be used as a power source for a working machine.

(7) The battery pack according to any one of (1) to (5), in which
the battery pack is mounted on a conveyance carriage (conveyance carriage 304) configured to be moved by driving a motor with electric power of the battery pack.

According to (7), the battery pack can be used as a battery of a conveyance carriage that conveys an object to be conveyed.

(8) The battery pack according to any one of (1) to (5), in which
the battery pack is mounted on a lawn mower (lawn mower 303) configured to rotate a blade by driving a motor with electric power of the battery pack.

According to (8), the battery pack can be used as a battery of a lawn mower.

(9) The battery pack according to any one of (1) to (5), in which
the battery pack is mounted on a two-wheeled vehicle (two-wheeled vehicle 302) configured to be operated by driving a motor with electric power of the battery pack.

According to (9), the battery pack can be used as a battery of an electric motorcycle.

(10) The battery pack according to any one of (1) to (5), in which
the battery pack is mounted on a four-wheeled vehicle (four-wheeled vehicle 301) configured to be operated by driving a motor with electric power of the battery pack.

According to (10), the battery pack can be used as a battery of an electric automobile.

(11) The battery pack according to any one of (1) to (5), in which
the battery pack is mounted on a stationary battery in which a plurality of the battery packs are laminated.

According to (11), the battery pack can be used as a stationary battery.

(12) The battery pack according to (11), in which
the stationary battery includes a battery pack after use for another purpose.

According to (12), it is possible to use the battery pack after use for another purpose, to reduce the number of battery packs to be discarded, and to effectively use resources.

### REFERENCE SIGNS LIST

10: battery pack
12: second seal member (sealing member)
15: lid member
20: case
25: cell accommodation space
27: output terminal accommodation space
30: cell laminate
40: battery cell
60: terminal block
61: output conductive member (conductive member)
70: lead-out conductive member (external conductive member)
91: first opening (opening)
301: four-wheeled vehicle
302: two-wheeled vehicle
303: lawn mower
304: conveyance carriage
305: electric power unit
L: central line of battery pack

What is claimed is:

1. A battery pack comprising:
a cell laminate in which a plurality of battery cells are laminated; and
a case that accommodates the cell laminate, wherein
the case includes
a cell accommodation space in which the cell laminate is accommodated and which is closed from an outside,
an output terminal accommodation space in which a conductive member extending from the cell accommodation space and an external conductive member entering through an opening are electrically connected, and
a lid member configured to detachably close the opening.

2. The battery pack according to claim 1, wherein
a sealing member is provided at a communication portion between the cell accommodation space and the output terminal accommodation space, and
the cell accommodation space is sealed.

3. The battery pack according to claim 1, wherein
the conductive member and the external conductive member are configured to be capable of being electrically connected by a bolt.

4. The battery pack according to claim 1, wherein
a terminal block to which the conductive member and the external conductive member are connected is offset in a width direction of the battery pack relative to a central line in the width direction.

5. The battery pack according to claim 1, wherein
an upper surface of the case has a flat surface or has a fitting shape which is capable of being fitted to a bottom surface of the case, and
the case is configured to be capable of being laminated in an upper-lower direction.

6. The battery pack according to claim 1, wherein
the battery pack is to be mounted in an electric power unit configured to drive a motor by electric power of the battery pack.

7. The battery pack according to claim 1, wherein
the battery pack is to be mounted in a conveyance carriage configured to be moved by driving a motor by electric power of the battery pack.

8. The battery pack according to claim 1, wherein
the battery pack is to be mounted in a lawn mower configured to rotate a blade by driving a motor by electric power of the battery pack.

9. The battery pack according to claim 1, wherein
the battery pack is to be mounted in a two-wheeled vehicle configured to be operated by driving a motor by electric power of the battery pack.

10. The battery pack according to claim 1, wherein
the battery pack is to be mounted in a four-wheeled vehicle configured to be operated by driving a motor by electric power of the battery pack.

11. The battery pack according to claim 1, wherein
the battery pack is to be mounted in a stationary battery in which a plurality of the battery packs are laminated.

12. The battery pack according to claim 11, wherein
the stationary battery includes a battery pack after use for another purpose.
